(19) United States
(12) Patent Application Publication
(10) Pub. No.: US 2005/0134889 A1
(43) Pub. Date: Jun. 23, 2005

(54) Image forming method, image forming apparatus, and image forming system

(75) Inventor: Toshiyuki Nakazawa, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/985,095

(22) Filed: Nov. 9, 2004

(30) Foreign Application Priority Data
Nov. 27, 2003 (JP) 2003-398045

(51) Int. Cl. G06F 3/12; G06F 13/00; G06F 11/30

(52) U.S. Cl. 358/1.13; 358/1.14; 710/19; 710/14

(57) ABSTRACT

An image forming apparatus has a local print mode in which print job data is printed using a printer unit of said image forming apparatus and a remote print mode in which print job data is printed using a printer unit of a different image forming apparatus. When one or more output process conditions for operation in the remote print mode have already been set, if the operation mode is switched from the remote print mode to the local print mode, the one or more output process conditions are maintained in setting the output process conditions in the local print mode.

### BACKGROUND OF THE INVENTION

1. Field of the Invention

The present invention relates to an image forming method, an image forming apparatus, and an image forming system, and more particularly, to an image forming method, an image forming apparatus, and an image forming system having a remote printing capability of forming an image at a remote location.

2. Description of the Related Art

In recent years, the use of networks in an office environment has become very popular. Many image forming apparatuses such as digital copiers and printers have a network connection capability, and systems including such image forming apparatuses are widely used to print or read image data at remote locations by transmitting image data via a network.

For example, Japanese Patent Laid-Open No. 2001-222190 discloses a remote copy technique where, when an image forming apparatus such as a copier is being used by another user or when the image forming apparatus cannot be used because of a failure or for some reason, image data is printed using a different apparatus.

However, in conventional techniques, the setting of output process conditions must be performed separately for a current apparatus (e.g., local apparatus) and a different apparatus (e.g., remote apparatus) which may be used instead of the local apparatus.

### SUMMARY OF THE INVENTION

In one aspect, the present invention provides an image forming apparatus having a local print mode in which print job data is printed using a printer unit of the image forming apparatus and a remote print mode in which print job data is printed using a printer unit of a different image forming apparatus. When one or more output process conditions for operation in the remote print mode have already been set, if the operation mode is switched from the remote print mode to the local print mode, the one or more previously set output process conditions are maintained in setting the output process conditions in the local print mode.

Other features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram of a digital copying system according to an embodiment of the present invention.

FIG. 2 is a block diagram showing a total control unit according to an embodiment of the present invention.

FIG. 3 is a flow chart showing a remote copying process performed by a digital copier under the control of the total control unit according to an embodiment of the present invention.

FIG. 4 is a diagram showing a user interface for specifying a printer on a network or specifying an address range of a printer according to an embodiment of the present invention.

FIG. 5 is a diagram showing a user interface for selecting a printer from a list of detected printers on a network according to an embodiment of the present invention.

FIG. 6 is a diagram showing an operation control panel including a user interface for specifying operation conditions in a remote copy operation according to an embodiment of the present invention.

FIG. 7 is a diagram showing an operation panel including a user interface for specifying operation conditions in a local copy operation according to an embodiment of the present invention.

FIG. 8 is a diagram showing an example of how operation conditions are displayed on an operation control panel of a digital copier after the operation mode is switched to a local copy mode according to an embodiment of the present invention.

FIG. 9 is a diagram showing another example of how operation conditions are displayed on an operation control panel of a digital copier after the operation mode is switched to a local copy mode according to an embodiment of the present invention.

FIG. 10 is a flow chart showing a remote copying process performed by a digital copier under the control of a total control unit according to an embodiment of the present invention.

FIG. 11 is a diagram showing a user interface for specifying whether to select a local copy mode according to an embodiment of the present invention.

### DESCRIPTION OF THE EMBODIMENTS

The present invention is described in further detail below with reference to embodiments in conjunction with accompanying drawings.

### First Embodiment

In the present embodiment of the invention, operations of various apparatuses and units are controlled in a unique manner as described below, and information is displayed on various user interfaces such as operation control screens in a unique manner as described below with reference to the drawings.

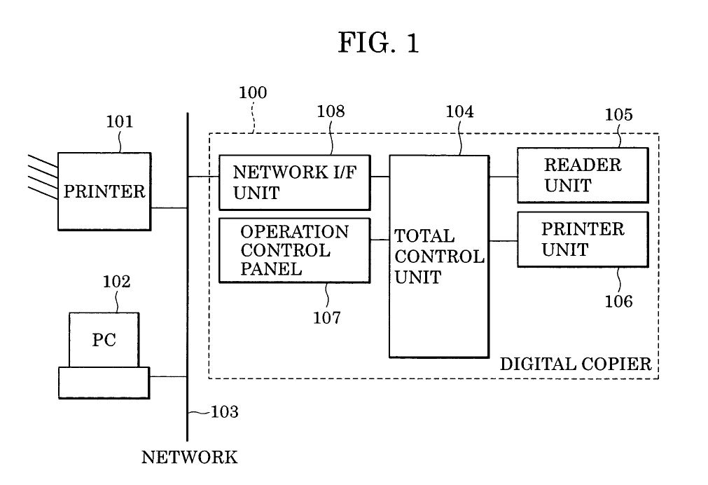

FIG. 1 is a block diagram of a digital copying system 100 according to a first embodiment of the present invention. The digital copying system 100 used as a first image forming apparatus, a printer 101 used as a second image forming apparatus, and a personal computer (PC) or a workstation 102 are connected to a network 103. In the present embodiment, a printer unit (not shown) in the printer 101 is used as remote image forming means.

A total control unit 104 controls the whole of the digital copier 100 and also various apparatuses and interfaces connected to the digital copier 100. In accordance with a command issued by a user, an image of a document is read by a reader unit 105, the resultant image data is transferred to a printer unit 106 serving as a first image forming means and stored in a storage device (not shown), such as a hard drive, in the digital copier 100. In another embodiment, the image data is transmitted to another printer 101 or the PC 102 connected to the network 103 via a network interface (I/F) 108.

The printer unit 106 serving as local image forming means prints document data read by the reader 105 or image data stored in the storage device disposed in the main part of the digital copier 100. When print data described in a page description language (PDL) is received from the PC 102 connected to the network 103 via the network interface 108, the printer unit 106 converts the received printer data into image data and prints it.

The network interface 108 is connected to the network 103 and is used by the total control unit 104 to communicate with other information devices connected to the network 103, such as the PC 102 or the printer 101. An operation control panel 107 contains items such as buttons and a display or a liquid crystal display (LCD) with a touch panel. The operation control panel 107 may include a combination of the aforementioned items, or any other items that would enable practice of the present invention. Under the control of the total control unit 104, the operation control panel 107 displays information for use by a user. When a user inputs a command or data via the operation control panel 107, the input command or data is transferred to the total control unit 104.

In the present embodiment, by way of example, a network is used as a communication medium. However, the communication medium is not limited to the network, and various types of communication methods using wireless and/or wired communication lines are available for communication with other apparatuses to transmit various types of data such as print image data, job data, commands such as a status request command, and status information transmitted in response to the status request command. Furthermore, the present invention is not limited to the digital copier 100, but the present invention is applicable to other types of image forming apparatuses having a communication capability, such as a printer having only a printer function, a multi-function printer (MFP) having both a coping capability and a printing capability).

The printer 101 performs printing in accordance with print data described in PDL or image data received via the network 103 from the PC 102 or the digital copier 100. If the printer 101 receives a request for operation mode information from the digital copier 100, the printer 101 returns operation mode information associated with the printer 101 to the digital copier 100. The operation mode information includes information indicating PDLs supported by the printer 101, information indicating whether the printer 101 has a stapler and/or two-sided printer unit, information indicating types and sizes of paper supported by the printer 101, and information indicating types and sizes of paper that are currently available.

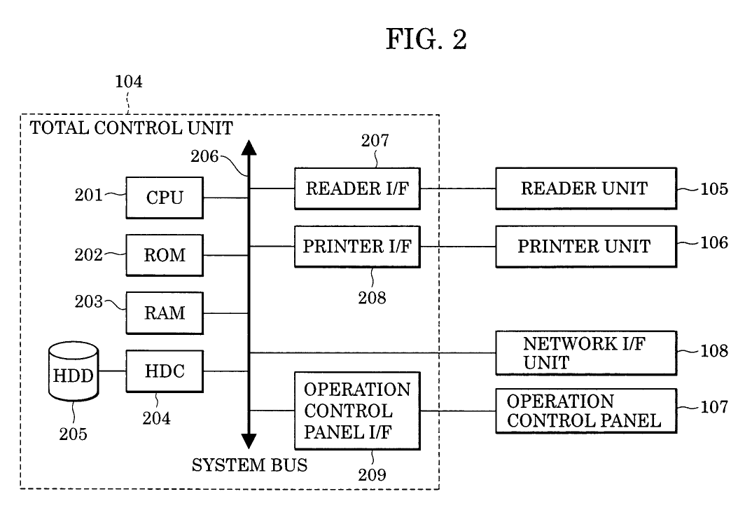

FIG. 2 is a block diagram showing the total control unit 104. A CPU 201 executes software stored in a ROM 202 or a hard disk (HDD) 205 and controls all of the components connected to system bus 206. A RAM 203 is used by the CPU 201 as a work area. A hard disk controller (HDC) 204 controls the HDD 205. A reader interface 207 controls a reader unit 105 connected to the reader interface 207. A printer interface 208 controls a printer unit 106 connected to the printer interface 208. An operation control panel interface 209 is connected to the operation control panel 107 and controls displaying of information on the operation control panel 107 and transferring of a command or data input by a user via the operation control panel 107.

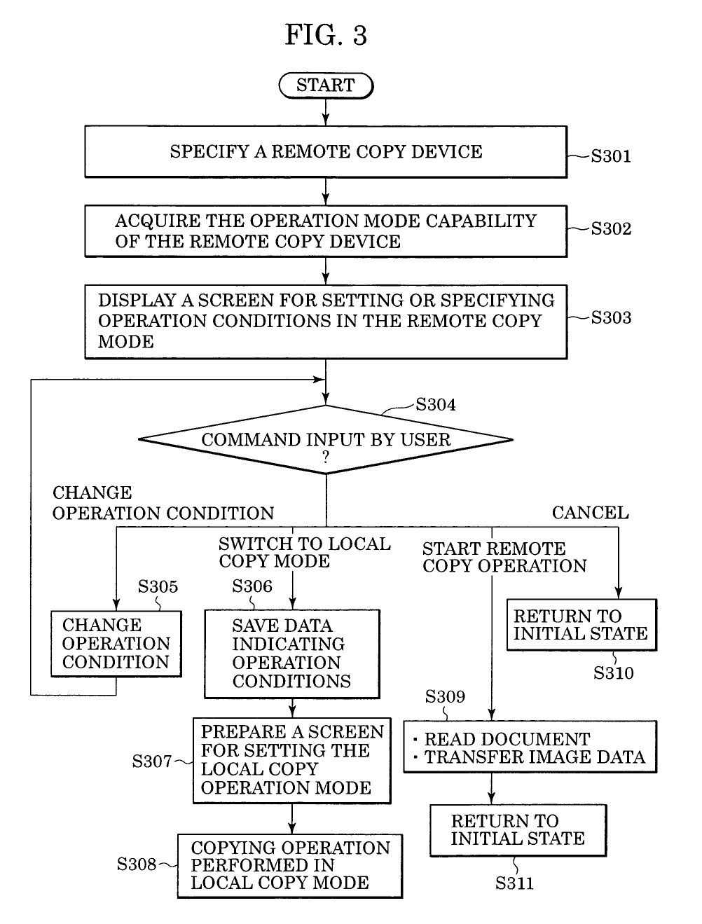

FIG. 3 is a flow chart showing a remote copying process performed by the digital copier 100 under the control of the total control unit 104 according to the present embodiment of the invention. First, in step S301, a command to perform copying using an image forming apparatus on a network (hereinafter, such a copying operation will be referred to as a remote copying operation) is issued and an image forming apparatus (remote image forming apparatus) to be used is selected. In this specific example, the printer 101 is selected as a remote image forming apparatus.

In the present embodiment, when job data is input in an image forming apparatus having a copying capability, the job data is not printed using this image forming apparatus, but rather the job data is transferred to a remote image forming apparatus to print the job data in the remote copy mode. In another embodiment, the image forming apparatus may have a printing capability but no copying capability. In this instance, the operation should be called a remote printing operation rather than a remote copying operation. In general, however, any operation in which job data is transferred from one image forming apparatus to another image forming apparatus to print the job data is generically referred to as a remote copying operation.

Turning back to FIG. 3, after printer 101 is specified in step S301, in step S302, operation capability information is acquired from the selected printer 101. This information includes, but is not limited to, availability and the position of a stapler, availability of a two-sided printing capability, the list of paper sizes, availability of a sorter and the number of bins, availability and the type of a puncher, and the available printing resolution. In step S303, based on the acquired operation capability information of the printer 101, a user interface 600 for setting operation conditions in the remote copying operation is displayed on the operation control panel 107.

Flow then proceeds to step S304, where the process waits for a command to be input by a user. If the user inputs a command to change an operation condition, for example, the number of sheets to be copied, the zooming ratio, or the finishing condition, then the process proceeds to step S305, where the operation condition is changed in accordance with the command. Thereafter, the process returns to step S305 and waits for a further command to be input by the user. If the user inputs a command to cancel the copying operation, the process proceeds to step S310. In step S310, the program ends the process and returns to the initial state. In the case in which the user inputs a command to start the remote copying operation, the process proceeds to step S309. In step S309, a document is read and a command is sent to the printer 101 to print the read image of the document in the specified operation conditions. After the printing is completed, the process proceeds to step S311, where it returns to the initial state.

In the case where the user issues, in step S304, a command to cancel the remote copying operation and switch the operation mode to a mode (local copy mode) in which copying is performed using the printer unit 106 of the digital copier 100, the process proceeds to step S306. In step S306, data indicating the operation conditions specified for use in the remote copy mode, such as document size, the size and type of print paper, the zooming ratio, the number of copies (sheets), the one-side/two-sided printing, finishing operation conditions regarding stapling, group sorting, non-sorting, simple sorting, punching, binding, and/or folding, a page layout such as 2 in 1, 4 in 1, 1 to 2, or 1 to 4, and/or an edit mode such as an image repeat mode, is stored. Then, in step S307, operation conditions in the local copy mode are displayed on the condition setting user interface 700 of the operation control panel 107 such that the operation conditions set for the remote copy mode are maintained. That is, parameters specified by the user for the remote copy mode are transferred to the local copy mode and conditions set in the remote copy mode are directly used in the local copy mode. Thereafter, in step S308, the copying operation is performed in the local copy mode.

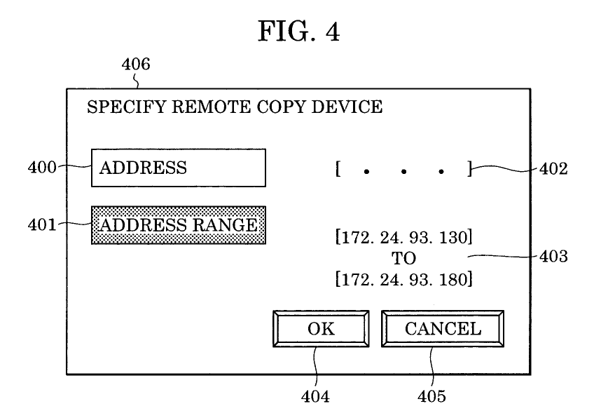

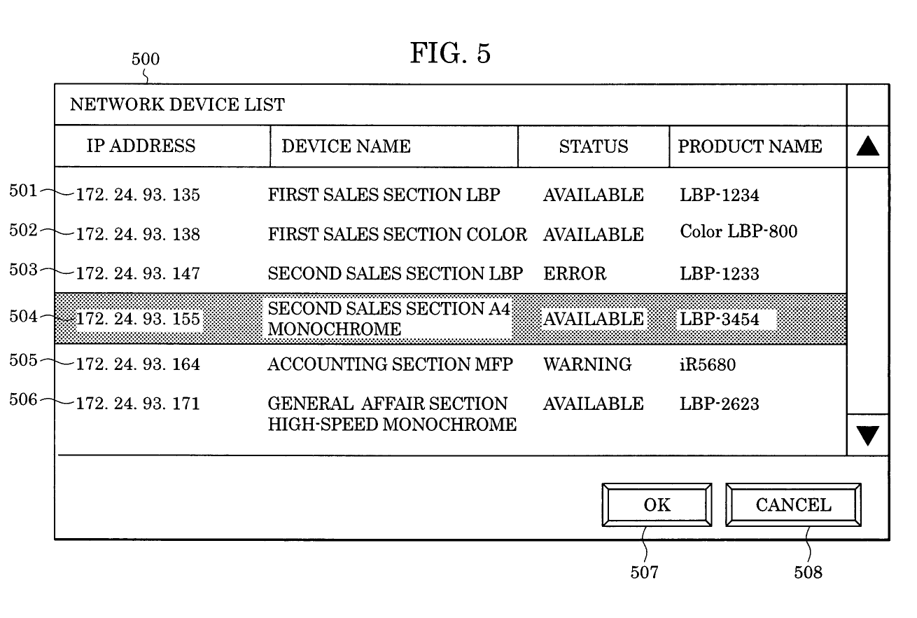

FIGS. 4 and 5 show examples of user interfaces 406, 500 displayed in step S301 to allow a user to select a printer to be used in the remote copy mode. When the remote copy mode is selected, a remote apparatus is selected as one of settings in the remote copy mode. More specifically, FIG. 4 shows a user interface 406 for specifying a particular printer on the network or an address range in which printers are located on the network, according to the present embodiment. When the IP address of a printer to be used is known, an address button 400 is selected and the IP address of the printer is input in an IP address field 402. When the IP address of the printer to be used is not known, an address range button 401 is selected and a network address range in which the printer is likely to be located is input in an IP address range field 403. If an “OK” button 404 is selected, the program searches for a network device having the specified IP address. However, if a “Cancel” button 405 is selected, the remote copy operation is canceled.

The retrieval of the printer on the network may also be performed by using broadcasting or SLP (Service Location Protocol). Searching for a remote apparatus is not necessarily needed when the remote copy mode is selected, as a particular remote apparatus may be specified in advance by a user as a default system setting of the digital copier 100.

Thus, via the process described above, when the remote copy mode is selected, an apparatus to be used in the remote copy operation is selected from a plurality of available apparatuses.

FIG. 5 is a diagram showing a user interface 500 for selecting a printer from a list of detected printers on the network according to the preset embodiment of the invention. In this example, printers 501 to 506 are detected on the network 103 as a result of the retrieval performed over the range specified in FIG. 4, or detected via retrieval by means of broadcasting, SLP, or the like. In addition to IP addresses of printers, printer names defined by users, the current status of printers, and product names are displayed as printer information in the form of a list. The information can be acquired from each printer by means of, for example, SNMP. For example, when a user selects printer 101 displayed in a row 504 in the list and presses an “OK” button 507, the printer 101 is selected as the printer to be used in the remote copy operation. If the “Cancel” button 508 is pressed, the remote copy operation is canceled, resulting in cancellation of the selection of the remote copy mode.

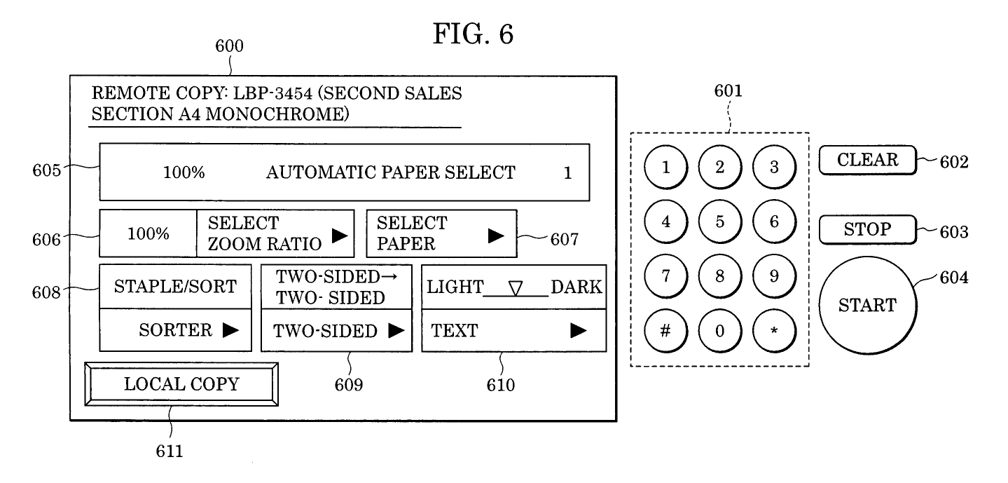

FIG. 6 is a diagram showing the operation control panel 107 including the user interface 600, displayed in step S303, to allow a user to set operation conditions in the remote copy mode. In more detail, a liquid crystal display with a touch panel provides a user interface (UI) 600 for displaying conditions in the copying operation or changing conditions. If a user touches a point in a field corresponding to a particular function, the function is executed. Some fields have a solid triangular symbol on the right-hand end of their field (e.g., select paper 607). If any of these fields are selected, a window containing a user interface for setting further detailed conditions is opened. In the example shown in FIG. 6, information displayed at the top of the user interface 600 indicates that a printer LBP-3454 (A4 monochrome type located in second sales section) is specified to be used in the remote copy mode.

A numeric keypad 601 is used to specify the number of copies or other values. If a “Clear” button 602 is pressed, the number of copies is reset to 1. A “Start” button 604 is used to start the copying operation in the specified conditions. When a “Stop” button 603 is pressed, the copying operation is stopped. If the “Start” button 604 is pressed again, the copying operation is restarted. Of various copying conditions, the zooming ratio (e.g., 100%), the paper size (e.g., automatic paper select), and the number of copies (e.g., 1) are displayed in an information display field 605. When it is necessary to set detailed settings, if field 606 is selected, a window for setting the zoom ratio appears. If field 607 is selected, a window for setting the paper type/size appears. The number of copies is set by using the numeric keypad 601 and the “Clear” key 602.

Field 608 is used to set finishing conditions such as stapling, punching, and sorting. The current setting as to the finishing conditions is displayed in this field 608. In the example shown in FIG. 6, stapling and sorting are specified to be performed as the finishing processing. Field 609 is used to specify whether the current document is one-sided or two-sided and whether printing should be performed in a one-sided or two-sided mode. The current setting as to the one-sided/two-sided conditions is displayed in field 609. In the example shown in FIG. 6, “Two-sided” is selected for the document type and “Two-sided” is selected for the printing mode. Field 610 is used to set the image density level in the reading operation and is also used to specify whether reading should be performed in a “Text” or “Image” mode. If “Local Copy” field 611 is selected, the operation mode is switched to the local copy mode while maintaining the setting as to the printing/outputting conditions specified in the remote copy mode. If “Local Copy” field is selected, the program executes step S306 and following steps shown in FIG. 3.

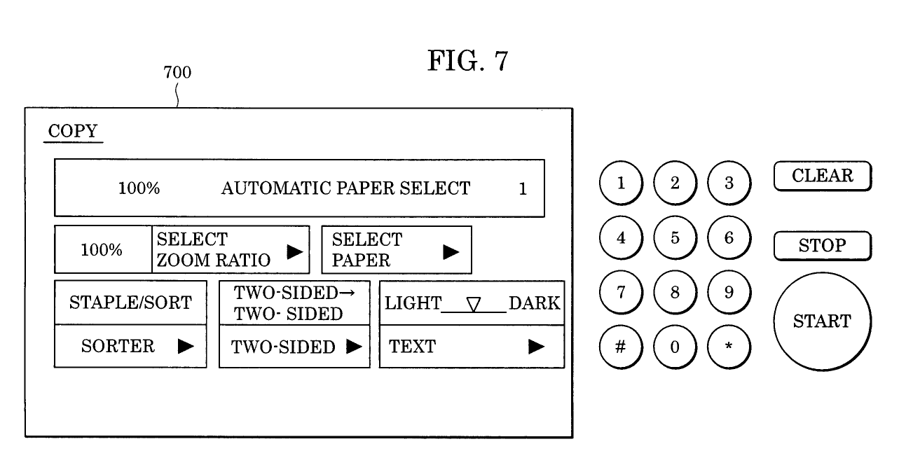

FIG. 7 shows an example of an operation control panel 107 including a user interface 700 for specifying operation conditions in a local copy operation (step S307 of FIG. 3) in response to selection of the “Local Copy” field 611 of FIG. 6. The information displayed on this user interface 700 is similar to that displayed on the remote copy setting user interface 600 shown in FIG. 6, except that information indicating the current operation mode is not displayed at the top of the user interface 700 and there is no “Local Copy” field 611.

As shown by the above examples, switching the operation mode from the remote copy mode to the local copy mode is accomplished by switching the image forming apparatus of the present embodiment from a state in which the remote copy mode is selected to a state in which the local copy mode is selected. In other words, the operation mode is switched from a mode in which a first operation sequence is performed to print job data (e.g., image data) input to the image forming apparatus of the present embodiment on a different apparatus to a mode in which a second operation sequence is performed to print the job data on the image forming apparatus of the present embodiment. In response to switching modes, the user interface is switched accordingly, i.e., from a mode for setting the remote copy operation to a mode for setting the local copy operation.

In the present embodiment, the total control unit 104 controls the display of information, such that information indicating the operation conditions specified in the remote copy mode is transferred directly to the user interface 700 for setting operation conditions in the local copy mode. That is, operation condition data set in the remote copy mode is maintained in the setting of the local copy mode. Thus, instead of printing the job data using a different apparatus in the remote copy mode, the job data is printed using the printer unit of the image forming apparatus of the present embodiment in accordance with the operation conditions set in the remote copy mode.

All operation conditions set in the remote copy mode may be used directly in the local copy mode, where printing is performed using the same conditions as those set via the user interface 700 in FIG. 7 simply by pressing the start key. Some conditions may be modified before pressing the start key or new operation conditions may be added. The operation condition setting user interface is displayed such that the above requirements are met.

The process of controlling the operation according to the present embodiment is described in further detail below.

In the present embodiment, the image forming apparatus has a capability of performing a printing operation in a mode selected from a plurality of modes, including the local copy mode, the local print mode, the remote copy mode, or the remote print mode, wherein the operation mode is selected by a user via the operation control panel 107 under the control of the total control unit 104 of the image forming apparatus.

In the case in which a user selects the remote copy mode by selecting the field on the operation control panel 107, the total control unit 104 displays, on the operation control panel 107, the user interface 600 that allows a user to specify various operation conditions, as described above, for job data (e.g., image data) in the remote copy mode. In addition, the user interface 600 also provides a field for switching the operation mode from the remote copy mode to the local copy mode while maintaining the operation conditions specified in the remote copy mode.

The data indicating the printing/outputting operation conditions specified via the user interface 600 for the remote copy mode is used not only when printing is performed by a remote apparatus in the remote copy mode, but is also used when the operation mode is switched to the local copy mode and printing is performed by the local apparatus. Therefore, in order that the data can be read by the total control unit 104 in any case, the data is stored in a memory. If the field for switching the operation mode to the local copy mode is selected, the total control unit 104 switches the operation mode to the local copy mode and displays the user interface 700 for setting operation conditions in the local copy mode on the operation control panel 107. Furthermore, the control unit reads from the memory the condition data indicating the printing/outputting operation conditions set for the remote copy mode and displays the printing/outputting operation conditions indicated by the condition data on the operation control panel 107. This allows the job data to be printed by the local apparatus using the same printing/output operation conditions as those set in the remote copy mode. If necessary, a user can modify the printing/outputting operation conditions transferred from the remote copy mode and displayed in the local copy setting user interface 700. Furthermore, a printing/outputting operation condition that is not set in the remote copy mode may be newly set in the local copy mode via the user interface 700.

If a user issues a print start command by pressing the start key on the operation control panel 107, the total control unit 104 controls the printer unit 106 of the local apparatus according to the specified printing/outputting operation conditions. In an alternative embodiment, the total control unit 104 displays a field for switching the operation mode to the remote copy mode on the user interface 700 of the operation control panel 107 in the local copy mode such that the operation mode can be again switched to the remote copy mode by selecting the field. In this alternative embodiment, when the operation mode is switched from the local copy mode to the remote copy mode, the printing/outputting operation conditions specified in the local copy mode are transferred to the remote copy mode and information indicating the printing/outputting operation conditions is displayed on the user interface 600 in the remote copy mode thereby allowing the print job data to be printed by the remote apparatus using the specified printing/outputting operation conditions.

If necessary, a user can modify or cancel, via the remote copy user interface 600, the printing/outputting operation conditions transferred from the local copy mode to the remote control mode. Furthermore, a printing/outputting operation condition that is not set in the local copy mode may be newly set in the remote copy mode via the user interface 600. If a user issues the print start command, by pressing the start key on the operation control panel 107, the total control unit 104 controls the printer unit of the remote apparatus according to the specified printing/outputting operation conditions.

In the present embodiment, as well as any additional embodiments, in either the local copy mode or the remote copy mode, various job data can be handled under the control of the total control unit 104. Job data that can be handled includes, for example, job data acquired via a scanner unit of an image forming apparatus and job data received from an external device such as a host computer and stored in a memory of the image forming apparatus.

### Second Embodiment

Now, a second embodiment will be described which is similar to the first embodiment in terms of the structure or the processing described above with reference to FIGS. 1 to 6. In the present embodiment, it is presumed that the printer 101 connected to the network and used as a remote apparatus in the remote copy mode has the capability of stapling in the finishing process, but the digital copier 100 does not have a stapling capability and thus a stapling setting option is not available.

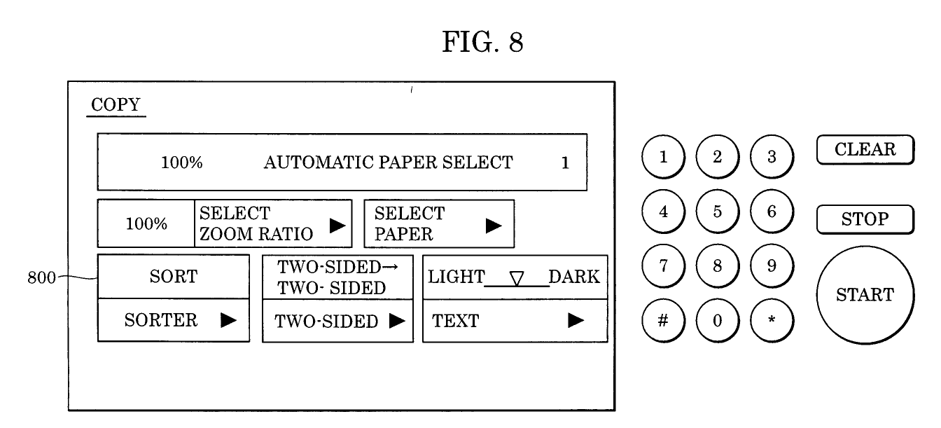

FIG. 8 shows an example of how information is displayed on the operation control panel 107 of the digital copier 100 when a user presses the “Local Copy” button 611 on the remote copy setting user interface 600 to switch the operation mode to the local copy mode. In this example, as compared to the example depicted in FIG. 6, the finishing process conditions are changed from sorting and stapling to sorting because the digital copier 100 does not have a stapling capability. The resultant changed finishing process conditions are displayed in a finishing condition field 800.

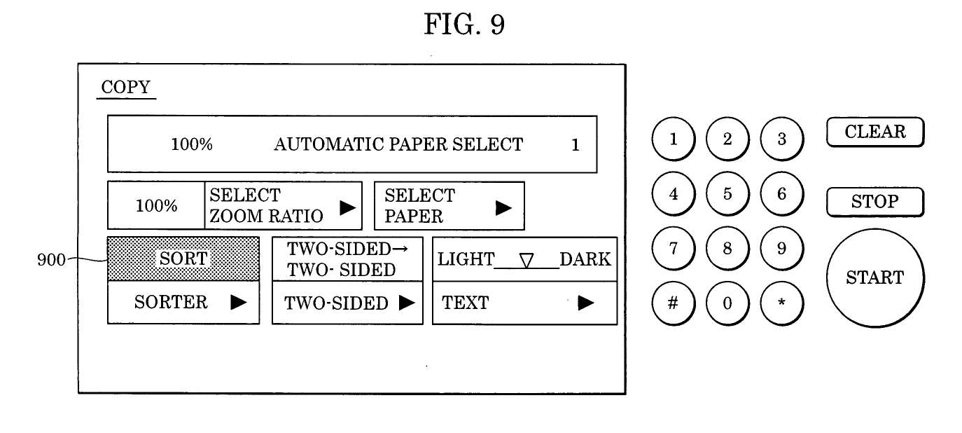

FIG. 9 depicts another example of how information is displayed on the operation control panel 107 of the digital copier 100 when a user selects the “Local Copy” field 611 on the remote copy setting user interface 600 to switch the operation mode to the local copy mode. In this example, as compared to the example depicted in FIG. 6, the finishing process conditions are changed from sorting and stapling to sorting because the digital copier 100 does not have a stapling capability. The resultant changed finishing process conditions are displayed in a finishing condition field 900 in a highlighted fashion to explicitly indicate that the finishing process conditions have been changed.

### Third Embodiment

A third embodiment of the present invention will now be described. The structure of the apparatus of the third embodiment is similar to the apparatuses of the first or second embodiments described above with reference to FIGS. 1 and 2. Retrieval of a remote printer and setting of operation conditions are performed in a similar manner as described above with reference to FIGS. 4 and 5.

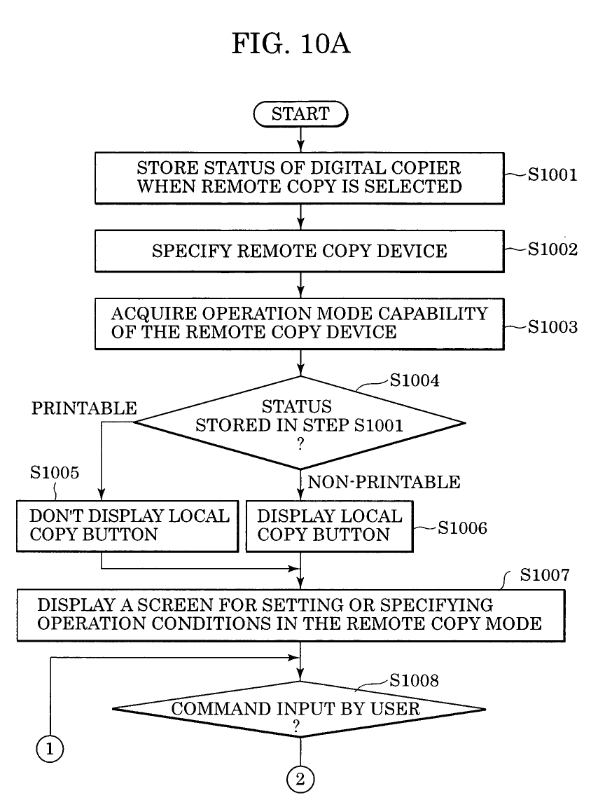

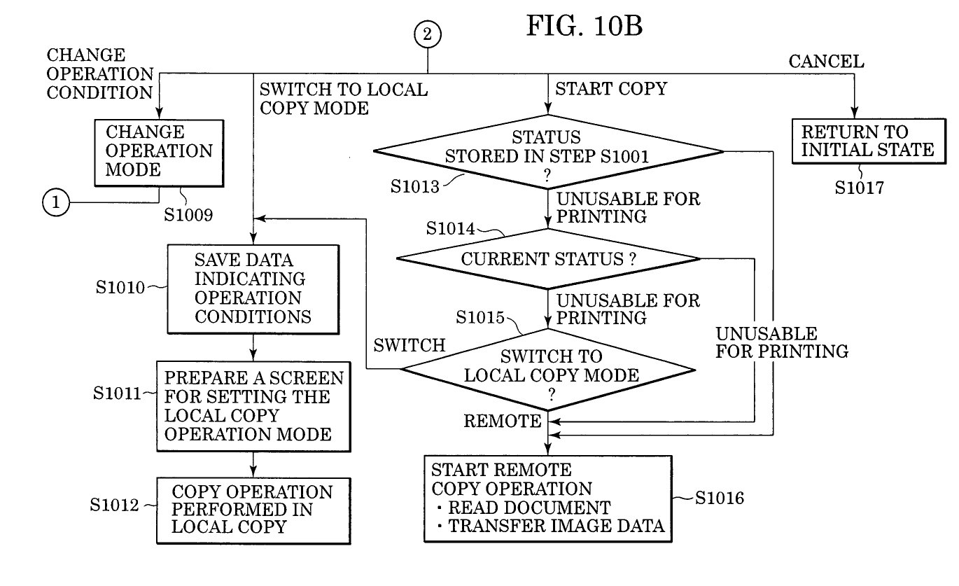

FIG. 10 is a flow chart showing a remote copying process performed by the digital copier 100 under the control of the total control unit 104 according to the third embodiment of the invention. If the remote copy mode is selected, then, in step S1001, the current status of the digital copier 100 is examined, and data indicating the current status is stored. In step S1002, a printer, e.g., printer 101, used as remote printer is specified. In step S1003, data indicating the capabilities of the printer 101 selected as the remote printer is acquired. Steps S1002 and S1003 described above are performed in a similar manner to steps S301 and S302 described in the previous embodiments.

In step S1004 a determination of the digital copier's 100 status at the time the remote copy mode is selected is made based on the data stored in step S1001. In the case in which the printer unit 106 of the digital copier 100 cannot be used for printing because the digital copier 100 is currently printing another job or a previous copying operation is not yet completed or for some other reason, it is very likely that the user has selected the remote copy mode because the printer unit 106 of the digital copier 100 cannot be used, although the user wants to use the digital copier 100 if it can be used. In this case, the local copy field for switching the operation mode to the local copy mode is displayed on the remote copy user interface 600 of the operation control panel 107 and the capability to switch to the local copy mode is enabled (step S1006). If the status data associated with the digital copier 100 indicates that the digital copier 100 is usable for printing, that is, if, when the remote copy mode is selected, the printer 106 is usable for printing, it is determined that the user does not want to use the digital copier 100 and wants to use a different apparatus in the remote copy mode. In this case, the local copy field is not displayed or the local copy field is displayed in an unselectable state (step S1005).

Depending on the capabilities of the printer 101 and depending on the result of the decision made in steps 1004 to 1006 as to whether to display the local copy field for switching the operation mode to the local copy mode, a user interface for setting operation conditions in the remote copy mode is displayed in step S1007 on the operation control panel 107. In step S1008, the process waits for a command to be input by a user.

If the user inputs a command to change operation conditions, such as the number of sheets to be copied, the zooming ratio, or the finishing condition, then the process proceeds to step S1009, where the specified operation condition is changed in accordance with the command. Thereafter, the process returns to step S1008 and waits for another command to be input by the user. If the user inputs a command to cancel the copying operation, the process proceeds to step S1017, where the program ends the process and returns to the initial state.

If the user issues a command to cancel the remote copy operation and switch the operation mode to the local copy mode using the printer unit 106 of the digital copier 100, then in step S1010, data indicating the operation conditions specified in the remote copy mode is stored. Subsequently, in step S1011, the local copy user interface 700 is displayed such that the operation conditions specified in the remote copy mode are maintained. In step S1012, the copy operation is performed in the local copy mode.

In the case in which the user inputs a command to start the remote copying operation, the copy operation is performed differently depending on the status of the digital copier 100 at the time the remote copy mode is selected by the user. More specifically, in step S1013, the status of the digital copier 100 at the time the remote copy command is selected, which was stored in step S1001, is checked. If the status of the digital copier 100 stored in step S1001 is “usable for printing” the process proceeds to step S1016 to perform the operation in the remote copy mode. On the other hand, if the status of the digital copier 100 stored in step S1001 is “unusable for printing”, the current status of the digital copier 100 is examined in step S1014.

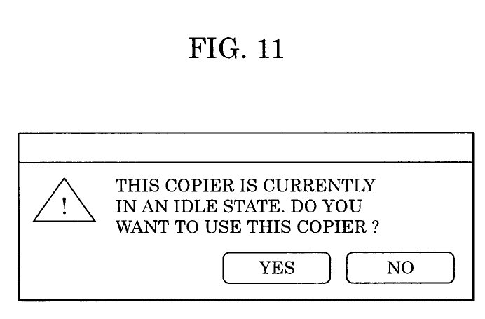

If the current status in step S1014 is “unusable for printing”, the process proceeds to step S1016 to perform the operation in the remote copy mode. However, if the current status in step S1014 is “usable for printing”, the process proceeds to step S1015, in which a user interface such as that shown in FIG. 11 is displayed indicating that the remote copy device selected in step S1002 is in an idle state and whether the user wishes to proceed with the remote copying operation (selection of “Yes” option) or switch to a local copying operation (selection of “No” option).

If user decides to switch to a local copying operation, the process proceeds to step S1010 and a local copying operation commences as described above. However, if the user decides not to switch to a local copying operation, the process proceeds to step S1016 to perform the operation in the remote copy mode.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-398045 filed Nov. 27, 2003, which is hereby incorporated by reference herein.

1. An image forming apparatus for printing, comprising:
selection means for selecting a first print mode in which print job data is printed using a printer unit of said image forming apparatus or a second print mode in which the print job data is transferred to a different image forming apparatus and the print job data is printed by a printer unit of the different image forming apparatus;
first setting means for setting one or more output process conditions in the second print mode;
mode switching means for, when the print mode is in the second print mode selected by the selection means, issuing a command to switch the print mode from the second print mode to the first print mode; and
second setting means for setting one or more output process conditions such that when the command to switch the print mode from the second print mode to the first print mode is issued by the mode switching means, one or more output process conditions in the first print mode is set such that the one or more output process conditions set by the first setting means in the first print mode are implemented.

2. An image forming apparatus according to claim 1, further comprising:
determination means for determining an operation state of said image forming apparatus; and
control means for controlling the mode switching means such that the mode switching means is enabled when the determination means determines that said image forming apparatus is in a state in which printing is impossible, and the mode switching means is disabled when the determination means determines that the present image forming apparatus is in a state in which printing is possible.

3. An image forming apparatus according to claim 2, further comprising display control means for controlling a display such that when the second print mode is selected by the selection means, if the determination means determines that the said image forming apparatus is in the state in which printing is possible, the display control means displays, on an operation control panel, information to prompt a user to switch the print mode to the first print mode.

4. An image forming apparatus having a plurality of operation modes including a first print mode in which print job data is printed using a printer unit of the image forming apparatus and a second print mode in which print job data is printed using a printer unit of a different image forming apparatus, the image forming apparatus comprising:
first display control means for displaying, on an operation control panel, a first user interface for setting one or more output process conditions in the first print mode;
second display control means for displaying, on the operation control panel, a second user interface for setting one or more output process conditions in the second print mode; and
mode switching means for issuing a command to switch the print mode from the second print mode to the first print mode;
wherein the first display control means displays the first user interface such that when the print mode is switched by the mode switching means, if one or more output process conditions in the second print mode have been set via the second display means, the one or more output process conditions are displayed in the first user interface.

5. An image forming apparatus according to claim 4, wherein the second display control means displays both the mode switching means and the second user interface for setting one or more output process conditions in the second print mode.

6. An image forming apparatus according to claim 5, further comprising determination means for determining a state of the image forming apparatus,
wherein, the second display control means displays both the mode switching means and the second user interface for setting one or more output process conditions in the second print mode if the determination means determines that the image forming apparatus is in a state in which printing is impossible and
wherein, neither the mode switching means nor the second user interface for setting one or more output process conditions in the second print mode are displayed if the determination means determines that the image forming apparatus is in a state in which printing is possible.

7. A method of controlling an image forming apparatus for printing, comprising:
a selection step of selecting a first print mode in which print job data is printed using a printer unit of the image forming apparatus or a second print mode in which the print job data is transferred to a different image forming apparatus and the print job data is printed by a printer unit of the different image forming apparatus;
a first setting step of setting one or more output process conditions in the second print mode;
a mode switching step of, when the print mode is in the second print mode selected in the selection step, issuing a command to switch the print mode from the second print mode to the first print mode; and
a second setting step of setting one or more output process conditions such that when the print mode is switched in the mode switching step from the second print mode to the first print mode, the one or more output process conditions set in the first setting step are used as one or more output process conditions in the first print mode.

8. A method of controlling an image forming apparatus for printing according to claim 7, further comprising
a determination step of determining an operation state of the image forming apparatus; and
a control step of enabling the mode switching step when it is determined in the determination step that the image forming apparatus is in a state in which printing is impossible, and disabling the mode switching step when it is determined in the determination step that the image forming apparatus is in a state in which printing is possible.

9. A method of controlling an image forming apparatus for printing according to claim 8, further comprising a display control step of controlling a display such that when the second print mode is selected in the selection step, if it is determined in the determination step that the image forming apparatus is in the state in which printing is possible, information is displayed on an operation control panel to prompt a user to switch the print mode to the first print mode.

10. A method of controlling an image forming apparatus having a plurality of operation modes including a first print mode in which print job data is printed using a printer unit of the image forming apparatus and a second print mode in which print job data is printed using a printer unit of a different image forming apparatus, the method comprising:
a first display step of displaying, on an operation control panel, a first user interface for setting one or more output process conditions in the first print mode;
a second display step of displaying, on the operation control panel, a second user interface for setting one or more output process conditions in the second print mode; and
a mode switching step of issuing a command to switch the print mode from the second print mode to the first print mode;
wherein in the first display control step, when the mode is switched to the first print mode in the mode switching step, if one or more output process conditions in the second print mode have been set in the second display control step, said one or more output process conditions are displayed in the first user interface.

11. A method of controlling an image forming apparatus according to claim 10, wherein in the second display control step, both mode switching means for executing the mode switching step and the second user interface for setting one or more output process conditions in the second print mode are displayed.

12. A method of controlling an image forming apparatus according to claim 11, further comprising a determination step of determining a state of the image forming apparatus,
wherein, in the second display control step, if it is determined in the determination step that the image forming apparatus is in the state in which printing is impossible, both the mode switching means and the second user interface for setting one or more output process conditions in the second print mode are displayed, and
wherein, neither the mode switching means nor the second user interface for setting one or more output process conditions in the second print mode are displayed if it is determined in the determination step that the image forming apparatus is in a state in which printing is possible.
